(19) United States
(12) Patent Application Publication
(10) Pub. No.: US 2017/0201710 A1
(43) Pub. Date: Jul. 13, 2017

(54) DISPLAY APPARATUS AND OPERATING METHOD THEREOF

(71) Applicant: SAMSUNG ELECTRONICS CO., LTD., Suwon-si (KR)

(72) Inventor: Je-ik KIM, Yongin-si (KR)

(21) Appl. No.: 15/398,968

(22) Filed: Jan. 5, 2017

(30) Foreign Application Priority Data
Jan. 11, 2016 (KR) 10-2016-0003348

(51) Int. Cl. H04N 5/445; H04N 9/64

(52) U.S. Cl. CPC H04N 5/44504; H04N 9/646; H04N 5/44591

(57) ABSTRACT

A display apparatus and an operating method thereof are disclosed. The display apparatus includes a display and a controller configured to acquire actual image content from among one or more pieces of content comprising a graphic frame, decode and image-quality process the acquired actual image content, acquire the graphic frame by merging the image-quality processed actual image content with other content comprising the graphic frame, and output the acquired graphic frame to the display.

### CROSS-REFERENCE TO RELATED APPLICATION

This application is based on and claims priority under 35 U.S.C. §119 to Korean Patent Application No. 10-2016-0003348, filed on Jan. 11, 2016, in the Korean Intellectual Property Office, the disclosure of which is incorporated by reference herein in its entirety.

### BACKGROUND

1. Field

The present disclosure relates generally to a display apparatus and an operating method thereof, and for example, to a display apparatus in which the image quality of images displayed thereby is improved, and an operating method of the display apparatus.

2. Description of Related Art

Display apparatuses have a function of displaying images for a user to view. For example, in the past, a television (TV), which is one example of a display apparatus, had only a function of receiving a broadcast signal transmitted from a broadcasting station only in one direction and displaying a broadcasting image. However, current display apparatuses have gradually been developed to provide various functions in addition to the function of displaying a broadcasting image received from a broadcasting station. Accordingly, while data to be displayed on a display apparatus is becoming increasingly varied, image quality of images displayed by the display apparatus may be deteriorated.

### SUMMARY

A display apparatus in which image quality of images displayed thereby is improved, and an operating method of the display apparatus are provided.

Additional aspects will be set forth in part in the description which follows and, in part, will be apparent from the description.

According to an example aspect of an example embodiment, a display apparatus includes: a display; a memory configured to store instructions; and a processor configured to execute the instructions to: acquire actual image content from among one or more pieces of content which is used in generating a graphic frame; decode and image-quality process the acquired actual image content; acquire the graphic frame by merging the image-quality processed actual image content with other content which is used in generating the graphic frame; and output the acquired graphic frame to the display.

The actual image content may include still image content or representative image content for indicating video content.

The actual image content may include a joint photographic experts group (JPEG) file or a JPG file.

The processor may be further configured to execute the instructions to perform the image-quality processing using a predefined conversion table in color space conversion in which the acquired actual image content is converted from YCbCr into RGB.

The image-quality processing may include at least one of color enhancement, brightness enhancement, contrast treatment, and RGB correction.

The processor may be further configured to execute the instructions to; acquire a mixed frame by mixing a video frame of video content and the graphic frame; and output the mixed frame to the display.

According to an example aspect of another example embodiment, a method of operating a display apparatus includes: acquiring actual image content from among one or more pieces of content which is used in generating a graphic frame; decoding and image-quality processing the acquired actual image content; acquiring the graphic frame by merging the image-quality processed actual image content with other content which is used in generating the graphic frame; and outputting the acquired graphic frame.

The actual image content may include still image content or representative image content for indicating video content.

The actual image content may include a joint photographic experts group (JPEG) file or a JPG file.

The decoding and image-quality processing of the acquired actual image content may include performing the image-quality processing by using a predefined conversion table in color space conversion in which the acquired actual image content is converted from YCbCr into RGB.

The image-quality processing may include at least one of color enhancement, brightness enhancement, contrast treatment, and RGB correction.

The method may further include: acquiring a mixed frame by mixing a video frame of video content and the graphic frame; and outputting the mixed frame.

### BRIEF DESCRIPTION OF THE DRAWINGS

These and/or other aspects and attendant advantages of the present disclosure will become apparent and more readily appreciated from the following detailed description, taken in conjunction with the accompanying drawings in which like reference numerals refer to like elements, and wherein:

FIG. 1 is a diagram illustrating an example display apparatus according to various example embodiments;

FIG. 2 is a diagram illustrating an example graphic frame acquired by a display apparatus according to various example embodiments;

FIG. 3 is a diagram illustrating an example method by which a display apparatus acquires a graphic frame, according to various example embodiments;

FIG. 4 is a diagram illustrating an example graphic plane in which a graphic frame is stored;

FIG. 5 is a diagram illustrating an example video frame and a graphic frame;

FIG. 6 is a diagram illustrating an example of mixing of a video frame and a graphic frame in a display apparatus, according to various example embodiments;

FIG. 7 is a diagram illustrating example screen images of the display apparatus, according to various example embodiments;

FIG. 8 is a block diagram illustrating an example display apparatus according to various example embodiments;

FIG. 9 is a diagram illustrating an example operation of a display apparatus, according to various example embodiments;

FIG. 10 is a block diagram illustrating an example display apparatus according to various example embodiments; and

FIG. 11 is a flowchart illustrating an example method of operating a display apparatus, according to various example embodiments.

### DETAILED DESCRIPTION

Reference will now be made in detail to various example embodiments, examples of which are illustrated in the accompanying drawings. In the drawings, parts irrelevant to the description may be omitted to clearly describe the example embodiments, and like reference numerals refer to like elements throughout the description. In this regard, the present embodiments may have different forms and should not be construed as being limited to the descriptions set forth herein. Accordingly, the example embodiments are merely described below, by referring to the figures, to explain various example aspects. As used herein, the term “and/or” includes any and all combinations of one or more of the associated listed items. Expressions such as “at least one of,” when preceding a list of elements, modify the entire list of elements and do not modify the individual elements of the list.

The terms used in this description are those general terms currently widely used in the art, but the terms may vary according to the intention of those of ordinary skill in the art, precedents, or new technology in the art. Also, specified terms may be arbitrarily selected, and in this case, the detailed meaning thereof will be described in the detailed description. Thus, the terms used in the description should be understood not as simple names but based on the meaning of the terms and the overall description.

Although terms, such as “first” and “second”, can be used to describe various elements, the elements cannot be limited by the terms. The terms can be used to classify a certain element from another element.

The terminology used in the description is used to describe various embodiments and does not have any intention to limit the disclosure. An expression in the singular includes an expression in the plural unless they are clearly different from each other in context. In addition, throughout the description, when it is described that a certain part is “connected” to another part, it should be understood that the certain part may be “directly connected” to another part or “electrically connected” to another part via another element in between. In addition, when a certain part “includes” a certain component, this indicates that the part may further include another component instead of excluding another component unless differently disclosed.

The term “the” and similar expressions of referral used in the description, particularly, in the claims, may indicate both the singular and plural in number. In addition, if there is no disclosure clearly designating an order of steps of describing a method according to the present disclosure, the described steps may be performed in any appropriate order. The present disclosure is not limited to the described order of steps.

The wording “according to various example embodiments” or “according to an example embodiment” appearing in various places of the present description does not necessarily indicate the same embodiment(s).

Some embodiments of the present disclosure can be represented with functional blocks and various processing steps. Some or all of these functional blocks can be implemented by various numbers of hardware and/or software configurations for executing specific functions. For example, the functional blocks of the present disclosure may be implemented by one or more microprocessors or by circuit configurations for predetermined functions. In addition, for example, the functional blocks of the present disclosure may be implemented by various programming or scripting languages. The functional blocks may be implemented by an algorithm executed by one or more processors. In addition, the present disclosure may adopt the prior art for an electronic environment configuration, signal processing, and/or data processing. Terms, such as “mechanism”, “element”, “means”, and “configuration”, may be widely used and are not limited to mechanical or physical configurations.

In addition, connections or connection members of lines between components shown in the drawings illustrate functional connections and/or physical or circuit connections, and the connections or connection members may be represented by a variety of replaceable or additional functional connections, physical connections, or circuit connections in an actual apparatus.

Hereinafter, the present disclosure is described in greater detail with reference to the accompanying drawings.

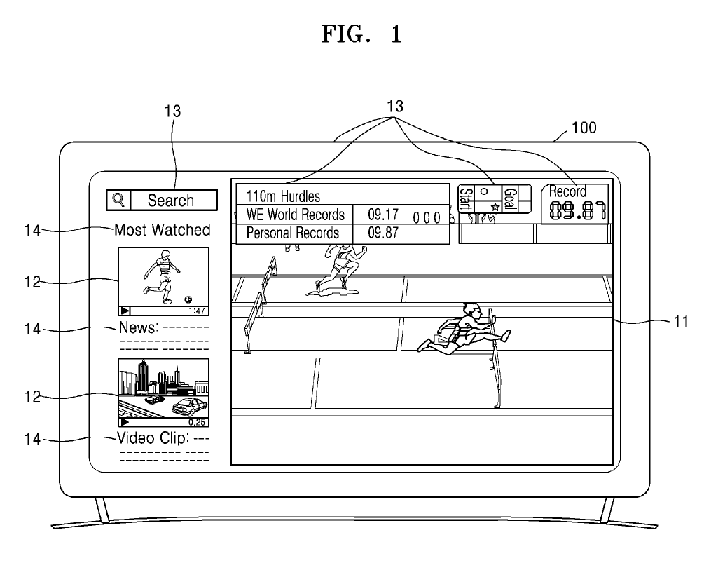

FIG. 1 is a diagram illustrating an example display apparatus 100 according to various example embodiments.

Referring to FIG. 1, the display apparatus 100 may be configured to output audio/video (A/V) content. The display apparatus 100 may output video content 11 of the A/V content to a screen and output audio content thereof to an acoustic output interface included in the display apparatus 100 or a speaker connected to the display apparatus 100.

The A/V content may be real-time broadcast content or non-real-time A/V content. For example, the non-real-time A/V content may be A/V content provided through a video on demand (VOD) service. The display apparatus 100 may receive the A/V content from an A/V content provider. The display apparatus 100 may receive the A/V content in a streaming or downloading manner. For example, the A/V content provider may be a broadcast service provider, a VOD service provider, or the like.

The display apparatus 100 may receive a broadcast signal and broadcast related information from the outside through a broadcast channel. The broadcast channel may include a satellite channel and a terrestrial channel. The display apparatus 100 may receive the A/V content through the broadcast channel or the Internet. Alternatively, the display apparatus 100 may receive the A/V content from an external device connected in a wired or wireless manner. Alternatively, the A/V content may be stored in a memory included in the display apparatus 100.

The display apparatus 100 may output one or more pieces of graphic content 12, 13, and 14 to the screen besides the video content 11. The one or more pieces of graphic content 12, 13, and 14 indicate various kinds of information which may be output to the screen as an actual image, a text, a graphic image, and the like. For example, the one or more pieces of graphic content 12, 13, and 14 may include an on-screen menu (OSD), program information, an electronic program guide (EPG), an application icon, an application window, a user interface (UI) window, subtitles corresponding to the video content 11, information related to the video content 11, a web browsing window, and the like. However, the one or more pieces of graphic content 12, 13, and 14 are not limited thereto.

The display apparatus 100 may divide the screen such that the video content 11 and the one or more pieces of graphic content 12, 13, and 14 are output without overlapping. Alternatively, the display apparatus 100 may output the one or more pieces of graphic content 12, 13, and 14 so as to overlap the video content 11. Alternatively, the display apparatus 100 may output the one or more pieces of graphic content 12, 13, and 14 such that some of the one or more pieces of graphic content 12, 13, and 14 do not overlap the video content 11 and the other some thereof overlap the video content 11. For example, the display apparatus 100 may output, onto the video content 11, graphic content corresponding to the subtitles corresponding to the video content 11 and information related to the video content 11 from among the one or more pieces of graphic content 12, 13, and 14. However, a screen image of the display apparatus 100 of FIG. 1 is only illustrative and does not limit an output method of the video content 11 and the one or more pieces of graphic content 12, 13, and 14.

The one or more pieces of graphic content 12, 13, and 14 may include actual image content 12, graphic image content 13, font content 14, and the like.

The actual image content 12 may be still image content or representative image content for indicating the video content 11. For example, the still image content may be an actual photograph. The representative image content for indicating the video content 11 may be a representative frame image of the video content 11, thumbnail images of the video content 11, or the like. The actual image content 12 may include a JPG file or a JPEG file compressed in a JPEG format, or the like.

The graphic image content 13 may be an artificially created image instead of an actual image. The graphic image content 13 may include a portable network graphics (PNG) file compressed in a PNG format. The font content 14 may be a text image having attributes of a specific size and style of typeface. The graphic image content 13 may include, as an image, characters having no font attribute.

The display apparatus 100 may acquire the one or more pieces of graphic content 12, 13, and 14 in various ways. The display apparatus 100 may acquire the one or more pieces of graphic content 12, 13, and 14 through a broadcast channel or the Internet. Alternatively, the display apparatus 100 may acquire the one or more pieces of graphic content 12, 13, and 14 from the memory included in the display apparatus 100. For example, an embedded UI may be stored in the memory.

The display apparatus 100 may acquire some of the one or more pieces of graphic content 12, 13, and 14 to be output to one screen through a broadcast channel or the Internet and acquire the other some thereof from the memory.

After acquiring the one or more pieces of graphic content 12, 13, and 14, the display apparatus 100 may acquire a graphic frame by merging the one or more pieces of graphic content 12, 13, and 14 to output the one or more pieces of graphic content 12, 13, and 14 to one screen.

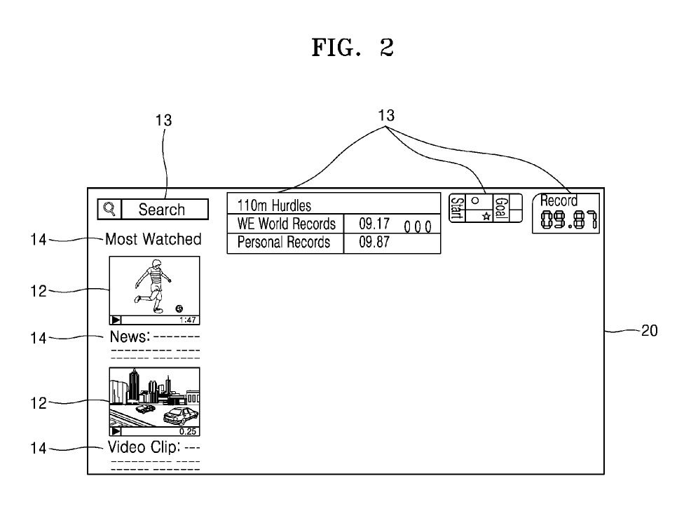

FIG. 2 is a diagram illustrating an example graphic frame acquired by a display apparatus according to various example embodiments.

Referring to FIG. 2, the display apparatus may acquire a graphic frame 20 by merging the one or more pieces of graphic content 12, 13, and 14. As described with reference to FIG. 1, the one or more pieces of graphic content 12, 13, and 14 may be files of different formats, respectively. In addition, the display apparatus may acquire the one or more pieces of graphic content 12, 13, and 14 from various sources such as a network, an external device, and an embedded memory.

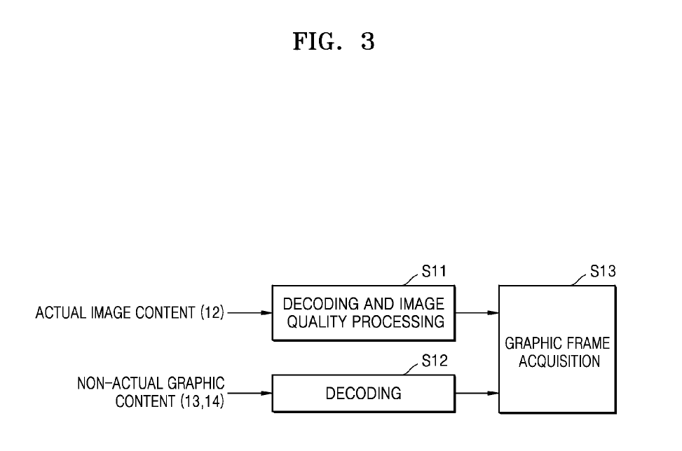

FIG. 3 is a diagram illustrating an example method by which a display apparatus acquires a graphic frame, according to various example embodiments.

Referring to FIG. 3, the display apparatus may acquire the one or more pieces of graphic content 12, 13, and 14. The display apparatus may identify the one or more pieces of graphic content 12, 13, and 14 as actual image content 12 and non-actual graphic content 13 and 14. The non-actual graphic content 13 and 14 may be graphic image content, font content, and the like as described with reference to FIG. 1.

The display apparatus may decode and image-quality process the actual image content 12 in operation S11. The display apparatus may decode the non-actual graphic content 13 and 14 in operation S12. The display apparatus may acquire a graphic frame by merging the decoded and image-quality processed actual image content 12 and the decoded non-actual graphic content 13 and 14 in operation S13.

According to various example embodiments, the display apparatus may prevent and/or reduce image quality deterioration by acquiring a graphic frame in which only the actual image content 12 is image-quality processed.

The non-actual graphic content 13 and 14 may be distinguished from the actual image content 12 in that the non-actual graphic content may refer to an artificially created image. In addition, the non-actual graphic content 13 and 14 may usually include a lossless-compressed file (e.g., a PNG file). On the other hand, the actual image content 12 may include a lossy-compressed file (e.g., a JPEG file).

Since the actual image content 12 has attributes other than those of the non-actual graphic content 13 and 14, when the actual image content 12 and the non-actual graphic content 13 and 14 are merged into a graphic frame to be displayed, image quality deterioration may occur.

According to various example embodiments, the display apparatus may distinguish the actual image content 12 from the non-actual graphic content 13 and 14 and image-quality process only the actual image content 12. The display apparatus may enhance image quality of the actual image content 12 and also prevent and/or reduce distortion of other content (e.g., the non-actual graphic content 13 and 14) by image-quality processing only the actual image content 12. Therefore, the entire image quality of a graphic frame may be improved. For example, the display apparatus may enhance image quality by performing selective image quality processing in decoding according to types of graphic content which is used in generating the graphic frame.

The display apparatus may distinguish the actual image content 12 from the other content (e.g., the non-actual graphic content 13 and 14) based on file formats of one or more acquired pieces of content. For example, the display apparatus may identify content of a JPG or JPEG file as the actual image content 12.

The display apparatus may perform decoding and image quality processing of the actual image content 12 at the same time, or perform decoding of the actual image content 12 and then perform image quality processing of the decoded actual image content 12. That is, the image quality processing may be performed together with the decoding or performed as post-processing after the decoding.

First, an example where the display apparatus performs the decoding and the image quality processing of the actual image content 12 at the same time will be described below.

The display apparatus may perform a color space conversion for converting YCbCr into RGB in the decoding of the actual image content 12. The display apparatus may perform the image quality processing by using a predefined conversion table in the color space conversion of the actual image content 12.

A standard relationship between RGB and YCbCr is represented by Equation 1.

R=Y+1.40200×Cr

G=Y−0.34414×Cb−0.71414×Cr

B=Y+1.77200×Cb (1)

The predefined conversion table used in the color space conversion of the actual image content 12 may be a table in which the coefficients of Equation 1 have been adjusted. The conversion table for the actual image content 12 may be experimentally acquired by outputting test patterns onto a screen of the display apparatus. The conversion table may vary according to panel characteristics of display apparatuses.

When the predefined conversion table is used in the color space conversion of the actual image content 12, the display apparatus may perform both the color space conversion, one of decoding processes, and the image quality processing. Therefore, the display apparatus may improve image quality without any additional hardware configuration or increased overhead of an additional computation. In addition, since the additional computation is not required, a time taken to perform a graphic frame acquisition process does not increase. Therefore, the performance of the display apparatus, which is apparent to a user, may not be lowered.

The display apparatus may perform the image quality processing through various types of post-processing after the decoding of the actual image content 12. Examples of the image quality processing may include at least one of color enhancement, brightness enhancement, contrast treatment, and RGB correction. However, an image quality processing method performed by the display apparatus is not limited to this list of examples. The display apparatus may perform the image quality processing through various types of post-processing after the decoding.

As an example of a case where various example embodiments are not applied, the display apparatus may acquire a graphic frame without performing image quality processing on all pieces of content which is used in generating the graphic frame. When the display apparatus outputs the graphic frame without image quality processing, image quality deterioration of the actual image content 12 on the screen may be apparent to the user. The image quality deterioration may occur due to the actual image content 12 being a lossless-compressed file.

As another example of the case where some example embodiments are not applied, the display apparatus may acquire a graphic frame without performing image quality processing on all pieces of content, then image-quality process the entire graphic frame, and output the image-quality processed graphic frame. In this case, image quality of the actual image content 12 may be improved, but distortion may occur in the non-actual graphic content 13 and 14.

As another example of the case where some example embodiments are not applied, the display apparatus may acquire a graphic frame without performing image quality processing on all pieces of content, then determine which region corresponds to the actual image content 12 and which region corresponds to the non-actual graphic content 13 and 14, and image-quality process only the region corresponding to the actual image content 12. In this case, the display apparatus requires a determination algorithm for identifying a specific region from the graphic frame. Due to this, an additional hardware configuration may be required, complexity of computation may increase, and additional costs may be incurred.

According to various example embodiments, the display apparatus may decode and image-quality process the actual image content 12 and merge this result with other content to acquire a graphic frame, thereby improving image quality without any additional overhead.

The display apparatus may acquire a graphic frame by drawing the graphic frame on a graphic plane. The graphic plane may temporarily store the graphic frame.

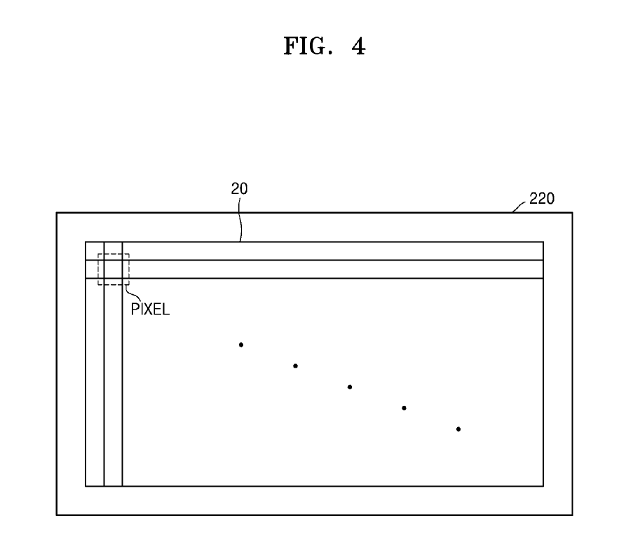

FIG. 4 is a diagram illustrating an example graphic plane 220 in which the graphic frame 20 is stored.

Referring to FIG. 4, the graphic plane 220 may be referred to as a buffer in which a display apparatus acquires and stores the graphic frame 20 to be output to a screen. The display apparatus may draw the graphic frame 20 on the graphic plane 220. The drawing of the graphic frame 20 on the graphic plane 220 may indicate writing, on the graphic plane 220, a pixel value of each of pixels comprising the graphic frame 20. For example, drawing the graphic frame 20 may indicate storing of the graphic frame 20.

The graphic frame 20 may include a plurality of pixels. Each of the plurality of pixels may have a pixel value. The pixel value may be RGB data. The RGB data may be represented as (R, G, B), wherein R, G, and B indicate red data, green data, and blue data, respectively. For example, when each data is represented using 8 bits, each of red, green, and blue has one of 256 levels. A color may be represented by mixing red, green, and blue represented by their respective levels. For example, RGB data of (255, 255, 255) indicates white, and RGB data of (0, 0, 0) indicates black.

The display apparatus may acquire the graphic frame 20 by merging one or more pieces of content and drawing the merged content on the graphic plane 220.

A decoding and image quality processing result of actual image content in the display apparatus may include RGB data. In addition, a decoding result of non-actual graphic content in the display apparatus may also include RGB data. The display apparatus may determine locations of pixels when each piece of graphic content is drawn on the graphic frame 20. The display apparatus may acquire the graphic frame 20 by merging and drawing pieces of graphic content through writing RGB data on locations of pixels determined for each piece of the graphic content. When the display apparatus draws the graphic frame 20, the graphic frame 20 may be temporarily stored in the graphic plane 220. The display apparatus may output the acquired graphic frame 20 onto the screen. When the graphic frame 20 is output, the display apparatus may draw a next graphic frame on the graphic plane 220.

However, as described with reference to FIG. 1, the display apparatus 100 may display the video content 11 together with the one or more pieces of graphic content 12, 13, and 14 on the screen. The display apparatus 100 may output, on to the screen, a video frame together with the graphic frame 20 acquired by merging the one or more pieces of graphic content 12, 13, and 14.

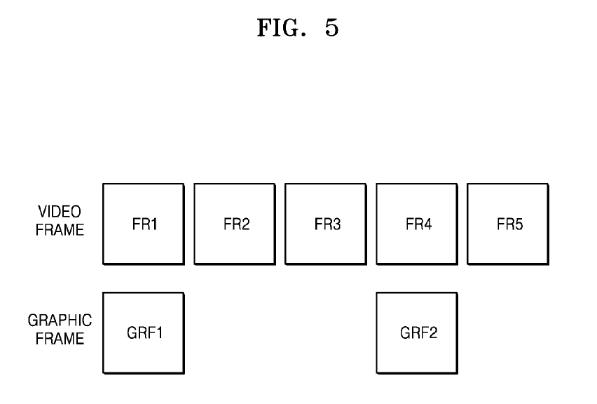

FIG. 5 is a diagram illustrating an example video frame and an example graphic frame.

Referring to FIG. 5, a display apparatus may acquire video content (11 of FIG. 1) and acquire a plurality of video frames FR1, FR2, FR3, FR4, and FR5 through image processing, such as decoding, on the video content. The display apparatus may acquire the video content as a file of a moving picture experts group (MPEG) format but is not limited thereto.

The display apparatus may output the plurality of video frames FR1, FR2, FR3, FR4, and FR5 at a frame rate. The frame rate is the number of video frames output per second.

The display apparatus may store the plurality of video frames FR1, FR2, FR3, FR4, and FR5 in a video plane. The video plane may be a buffer in which the display apparatus acquires and stores the plurality of video frames FR1, FR2, FR3, FR4, and FR5 to be output to a screen. One video plane may store one video frame. When the display apparatus includes one video plane, the display apparatus may store a next video frame (e.g., FR2) in the video plane after outputting a current video frame (e.g., FR1). The display apparatus may include a plurality of video planes.

Graphic frames GFR1 and GFR2 may be acquired as described above with reference to FIGS. 2 to 4, and thus, a repetitive description thereof is omitted.

The display apparatus may individually acquire and process the plurality of video frames FR1, FR2, FR3, FR4, and FR5 and the graphic frames GFR1 and GFR2.

The display apparatus may mix and output the plurality of video frames FR1, FR2, FR3, FR4, and FR5 and the graphic frames GFR1 and GFR2. The video frames FR1, FR2, and FR3 may be mixed with the graphic frame GFR1, and the video frames FR4 and FR5 may be mixed with the graphic frame GFR2.

Compared with the plurality of video frames FR1, FR2, FR3, FR4, and FR5, a switching time of the graphic frames GFR1 and GFR2 from a current frame (e.g., GFR1) to a next frame (e.g., GFR2) may not be constant.

Although not shown in FIG. 5, when the display apparatus has no video frames to be output together with a graphic frame, the display apparatus may output only the graphic frame to the screen.

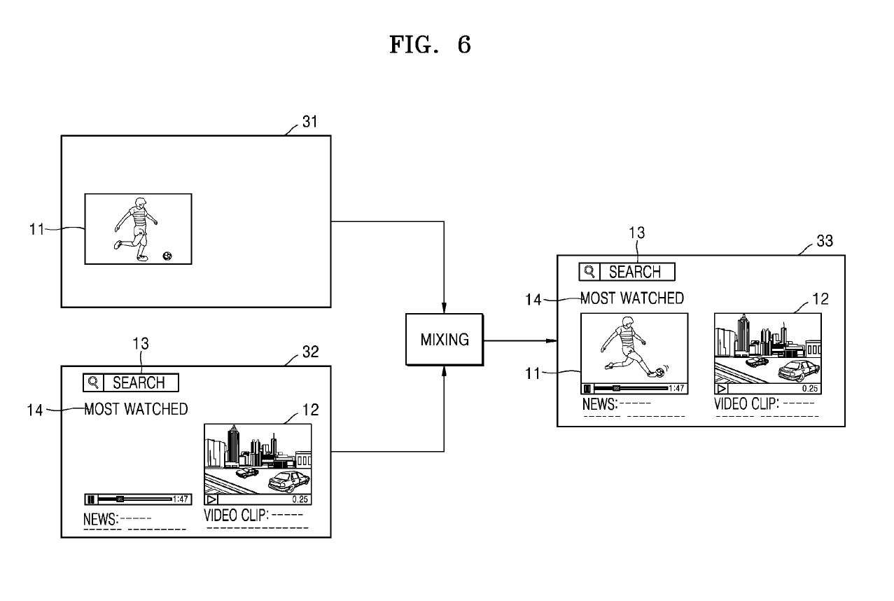

FIG. 6 is a diagram illustrating an example of mixing of a video frame and a graphic frame in a display apparatus, according to various example embodiments.

Referring to FIG. 6, the display apparatus may acquire a video frame 31 of the video content 11. The display apparatus may acquire a graphic frame 32 by merging the one or more pieces of graphic content 12, 13, and 14.

The display apparatus may acquire a frame 33 by mixing the video frame 31 and the graphic frame 32. The display apparatus may output the acquired frame 33 to a screen.

The above description may be applied to decoding and image quality processing of the actual image content 12 to acquire the graphic frame 32. By doing this, the display apparatus may provide a screen image in which image quality of the actual image content 12 has been improved.

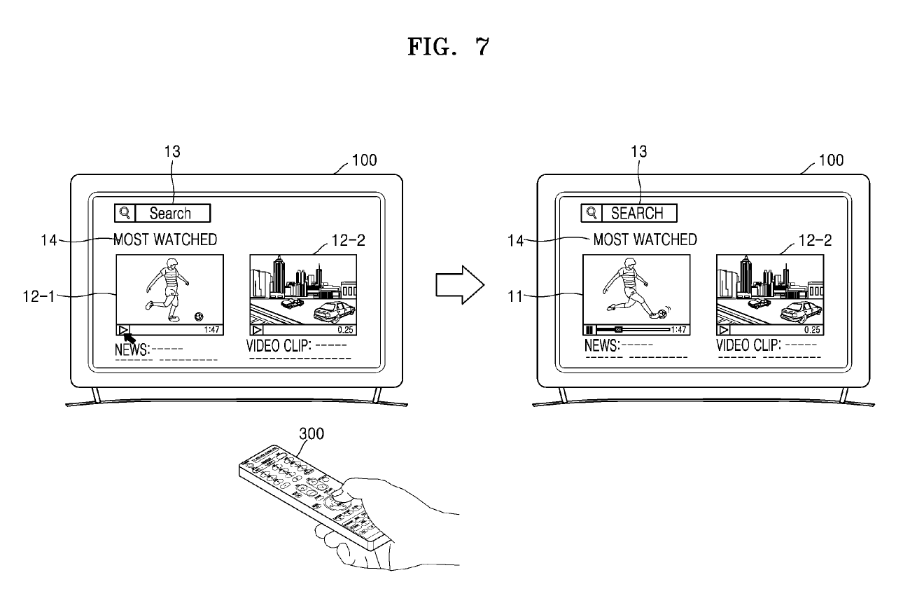

FIG. 7 is a diagram illustrating example screen images of the display apparatus 100, according to various example embodiments.

Referring to FIG. 7, the display apparatus 100 may output, onto the screen, a graphic frame in which one or more pieces of graphic content 12-1, 12-2, 13, and 14 are merged. When there is no video content, the display apparatus 100 may output only the graphic frame. The one or more pieces of graphic content 12-1, 12-2, 13, and 14 may include two pieces of actual image content 12-1 and 12-2, graphic image content 13, font content 14, and the like.

The two pieces of actual image content 12-1 and 12-2 may representative image content indicating video content. The display apparatus 100 may receive, from a control device 300, a user input for selecting one piece of actual image content 12-1. The display apparatus 100 may output the video content 11 corresponding to the selected actual image content 12-1. The display apparatus 100 may acquire a frame, such as the frame 33 in FIG. 6, through which the video content 11 is output.

The control device 300 may remote-control the display apparatus 100. The user may command, through the control device 300, to output the video content 11 corresponding to the actual image content 12-1. Besides, the user may control, through the control device 300, the display apparatus 100 in various ways, such as turning on or off the display apparatus 100, changing a channel, adjusting a volume, selecting a broadcast type such as terrestrial broadcast/cable broadcast/satellite broadcast, and setting an environment of the display apparatus 100. The control device 300 may be a TV remote control, a pointing remote control, a mouse motion recognizer, or the like but is not limited thereto. The control device 300 shown in FIG. 7 is only illustrative, and any type of control device capable of controlling the display apparatus 100 may be the control device 300.

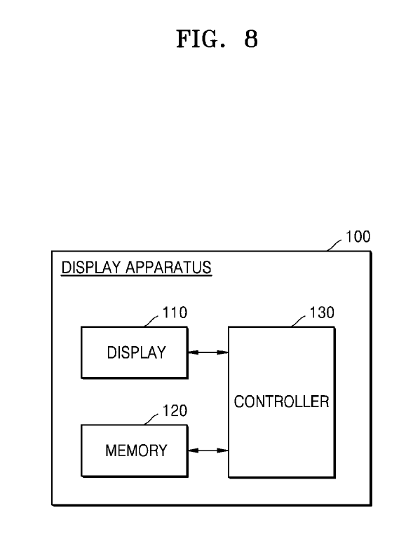

FIG. 8 is a block diagram illustrating an example display apparatus 100 according to various example embodiments.

Referring to FIG. 8, the display apparatus 100 may include a display 110, a memory 120, and a controller (e.g., including processing circuitry) 130.

The display 110 may output a video frame, a graphic frame, or a frame in which a video frame and a graphic frame are mixed, which has been acquired by the controller 130.

The memory 120 may store one or more programs to be executed by the controller 130. The one or more programs may include one or more instructions. The memory 120 may include buffers such as a graphic plane and a video plane.

The controller 130 may include various processing circuitry, such as, for example, one or more processors to control a general operation of components of the display apparatus 100.

The controller 130 may acquire actual image content from among one or more pieces of content which is used in generating a graphic frame. The controller 130 may acquire a graphic frame by decoding and image-quality processing the acquired actual image content and merging the image-quality processed actual image content with other content. The controller 130 may output the acquired graphic frame to the display 110.

The controller 130 may acquire a video frame for video content, mix the acquired video frame with a graphic frame, and output the mixed frame to the display 110.

The actual image content may include still image content or representative image content for indicating video content. The actual image content may include a JPEG or JPG file.

The controller 130 may perform image quality processing by using a predefined conversion table in color space conversion for converting the acquired actual image content from YCbCr into RGB. Besides, the image quality processing may include at least one of color enhancement, brightness enhancement, contrast treatment, and RGB correction.

The controller 130 may acquire a mixed frame by mixing the video frame for the video content and the graphic frame and output the mixed frame to the display 110.

Although not described again, the controller 130 may perform the operations to be performed by the display apparatus, which has been described with reference to FIGS. 1 to 7.

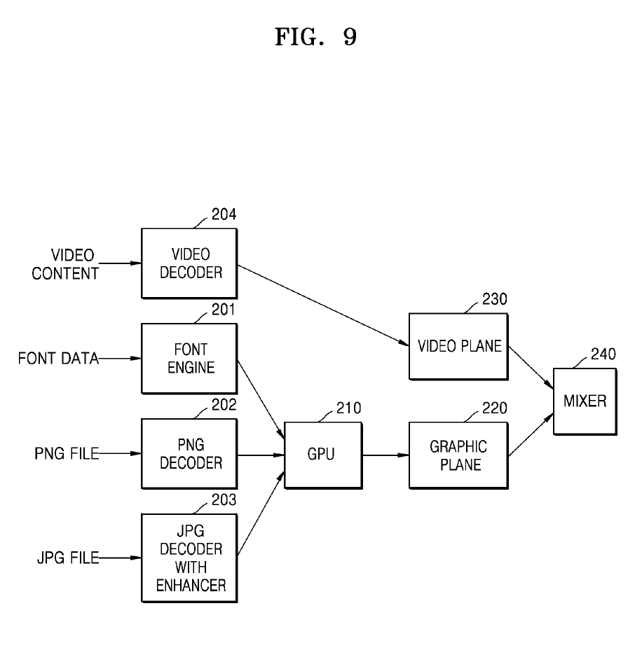

FIG. 9 is a diagram illustrating an example operation of a display apparatus, according to various example embodiments.

Referring to FIG. 9, the display apparatus may, for example, acquire video content, font data, a PNG file, and a JPG file. The font data, the PNG file, and the JPG file may be pieces of content which is used in generating a graphic frame. However, this is only illustrative, and the pieces of content which is used in generating the graphic frame may be obtained through the combination of various pieces of content.

The display apparatus may decode the video content using a video decoder 204. The display apparatus may image-quality process the decoded video content. The display apparatus may store the decoded video content as a video frame in a video plane 230.

The display apparatus may identify a format of each of the pieces of content which is used in generating the graphic frame. The display apparatus may decode the pieces of content based on the format of each of the pieces of content. The font data may be decoded by a font engine 201, and the PNG file may be decoded by a PNG decoder 202.

The display apparatus may decode and image-quality process the JPG file using a JPG decoder 203 with an enhancer.

The display apparatus may draw, through a graphic processing unit (GPU) 210, the graphic frame on a graphic plane 220 by merging the decoded font data, the decoded PNG file, and the decoded and image-quality processed JPG file. Therefore, the graphic frame which has been image-quality-improved only for the JPG file and has not been distorted for the font data and the PNG file may be acquired.

A mixer 240 of the display apparatus may acquire a frame by mixing the video frame stored in the video plane 230 and the graphic frame stored in the graphic plane 220. The display apparatus may output the mixed frame onto a screen.

The video decoder 204, the font engine 201, the PNG decoder 202, and the JPG decoder 203 may be programs to be executed by the controller 130 of the display apparatus 100 of FIG. 8, and the programs may be stored in the memory 120.

The GPU 210 and the mixer 240 may be included in or controlled by the controller 130 of FIG. 8.

Each of the video plane 230 and the graphic plane 220 may be a buffer and may be included in the memory 120 of FIG. 8.

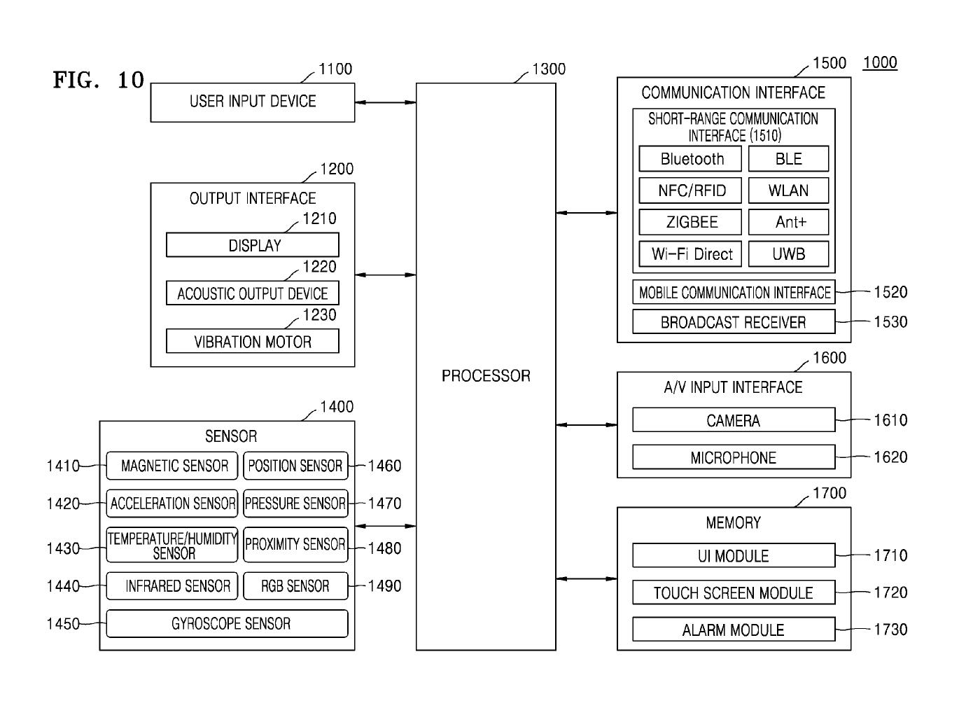

FIG. 10 is a block diagram illustrating an example display apparatus 1000 according to various example embodiments. The display apparatus 1000 of FIG. 10 may be another example of the display apparatus 100 of FIG. 8. However, not all of the components shown in FIG. 10 are mandatory components of the display apparatus 1000. The display apparatus 1000 may be implemented by more or less components than the components illustrated in FIG. 10.

Referring to FIG. 10, the display apparatus 1000 may include a user input interface (e.g., including interface circuitry) 1100, an output interface (e.g., including output circuitry) 1200, a controller (e.g., including processing circuitry) 1300, a sensor 1400, a communication interface (e.g., including communication circuitry) 1500, an A/V input interface (e.g., including A/V input circuitry) 1600, and a memory 1700.

The user input interface 1100 may include various input circuitry that provide a means through which a user inputs data for controlling the display apparatus 1000. The user input interface 1100 may receive a user's input for controlling the display apparatus 1000. For example, the user input interface 1100 may include various input circuitry, such as, for example, and without limitation, a keypad, a dome switch, a touch pad (a capacitive overlay touch pad, a resistive overlay touch pad, an infrared (IR) beam touch pad, a surface acoustic wave touch pad, an integral strain gauge touch pad, a piezoelectric touch pad, or the like), a jog wheel, a jog switch, and the like but is not limited thereto. In addition, for example, the user input interface 1100 may be an interface for receiving a user input signal from an external input device (not shown).

The output interface 1200 may include various output circuitry configured to output an audio signal, a video signal, or a vibration signal and may include, for example, and without limitation, a display 1210, an acoustic output interface 1220, and a vibration motor 1230.

The display 1210 displays data processed by the display apparatus 1000. The display 1210 may output a video frame, a graphic frame, or a frame in which a video frame and a graphic frame are mixed, which has been acquired by the controller 1300.

When the display 1210 and a touch pad form a layer structure to configure a touch screen, the display 1210 may be used as not only an output device but also an input device. The display 1210 may include at least one of a liquid crystal display, a thin-film transistor liquid crystal display, an organic light-emitting diode, a flexible display, a three-dimensional (3D) display, and an electrophoretic display, or the like, but is not limited thereto. The display apparatus 1000 may include two or more displays 1210 according to an implementation form of the display apparatus 1000. The two or more displays 1210 may be disposed to face each other by using a hinge.

The acoustic output interface 1220 may output audio content received through the communication interface 1500 or stored in the memory 1700. In addition, the acoustic output interface 1220 may output an acoustic signal related to a function (e.g., a call signal reception sound, a message reception sound, or an alarm sound) performed by the display apparatus 1000. The acoustic output interface 1220 may include various output circuitry, such as, for example, and without limitation, a speaker, a buzzer, and the like.

The vibration motor 1230 may output a vibration signal. For example, the vibration motor 1230 may output a vibration signal corresponding to an output of audio content or video content (e.g., a call signal reception sound or a message reception sound). In addition, the vibration motor 1230 may output a vibration signal when a touch is input through the touch screen.

The controller 1300 may include various processing circuitry configured to commonly control a general operation of the display apparatus 1000. The controller 1300 may control the other components in the display apparatus 1000 to execute the above-described operations of the display apparatus 1000. For example, the controller 1300 may generally control the user input interface 1100, the output interface 1200, the sensor 1400, the communication interface 1500, the A/V input interface 1600, and the like by executing programs stored in the memory 770.

For example, the controller 1300 may acquire actual image content from among one or more pieces of content constituting a graphic frame. The controller 1300 may acquire a graphic frame by decoding and image-quality processing the acquired actual image content and merging the image-quality processed actual image content with other content. The controller 1300 may output the acquired graphic frame to the display 1210.

The controller 1300 may acquire a video frame for video content, mix the acquired video frame with the graphic frame, and output the mixed frame to the display 1210.

The controller 1300 may perform image quality processing by using a predefined conversion table in color space conversion for converting the acquired actual image content from YCbCr into RGB. Besides, the image quality processing may include at least one of color enhancement, brightness enhancement, contrast treatment, and RGB correction.

The controller 1300 may acquire a mixed frame by mixing the video frame for the video content and the graphic frame and output the mixed frame to the display 1210.

Although not described again, the controller 1300 may perform the operations to be performed by the display apparatus, which has been described with reference to FIGS. 1 to 8.

The sensor 1400 may detect a state of the display apparatus 1000 or an ambient state of the display apparatus 1000 and transmit the detected information to the controller 1300.

The sensor 1400 may include, for example, and without limitation, at least one of a magnetic sensor 1410, an acceleration sensor 1420, a temperature/humidity sensor 1430, an IR sensor 1440, a gyroscope sensor 1450, a position sensor (e.g., global positioning system (GPS) 1460, an atmospheric pressure sensor 1470, a proximity sensor 1480, and an RGB (illuminance) sensor 1490 but is not limited thereto. A function of each sensor may be intuitively inferred by those of ordinary skill in the art from a name thereof, and thus a detailed description thereof is omitted herein.

The communication interface 1500 may include various communication circuitry, such as, for example, and without limitation, a short-range wireless communication interface 1510, a mobile communication interface 1520, and a broadcast receiver 1530.

The short-range wireless communication interface 1510 may include various communication circuitry, such as, for example, and without limitation, a Bluetooth communication interface, a Bluetooth low energy (BLE) communication interface, a near-field communication interface, a wireless local area network (WLAN) (Wi-Fi) communication interface (not shown), a Zigbee communication interface, an infrared data association (IrDA) communication interface (not shown), Wi-Fi Direct (WFD) communication interface, an ultra-wideband (UWB) communication interface, an Ant+ communication interface, and the like but is not limited thereto.

The mobile communication interface 1520 may transmit and receive a wireless signal to and from at least one of a base station, an external terminal, and a server in a mobile communication network. Herein the wireless signal may include a voice call signal, a video call signal, or various types of data according to text/multimedia message transmission and reception.

The broadcast receiver 1530 may receive a broadcast signal and/or broadcast related information from the outside through a broadcast channel, and the broadcast channel may include a satellite channel and a terrestrial channel.

The A/V input interface 1600 may include various interface circuitry configured to input an audio signal or a video signal and may include, for example, and without limitation, a camera 1610, a microphone 1620, and the like. The camera 1610 may receive a still image, a moving picture, or the like through an image sensor in a video call mode or a capturing mode. An image captured through the image sensor may be processed by the controller 1300 or a separate image processor (not shown).

The still image or moving picture processed by the camera 1610 may be stored in the memory 1700 or transmitted to the outside through the communication interface 1500.

The microphone 1620 may receive an external acoustic signal and process the external acoustic signal to electrical voice data. For example, the microphone 1620 may receive an acoustic signal from an external device or a speaker. The microphone 1620 may use various noise cancellation algorithms to cancel noise generated during a process of receiving an external acoustic signal.

The memory 1700 may store programs for processing and control of the controller 1300 and store data input to the display apparatus 1000 or output from the display apparatus 1000.

The memory 1700 may include at least one type of storage medium from among a flash memory type memory, a hard disk type memory, a multimedia card micro type memory, a card type memory (e.g., a secure digital (SD) or extreme digital (XD) memory), random access memory (RAM), static RAM (SRAM), read only memory (ROM), electrically erasable programmable ROM (EEPROM), PROM, a magnetic memory, a magnetic disc, and an optical disc.

The programs stored in the memory 1700 may be classified into a plurality of modules according to functions thereof, e.g., a UI module 1710, a touch screen module 1720, an alarm module 1730, and the like.

The UI module 1710 may provide a specified UI, a specified graphic user interface (GUI), or the like interoperating with the display apparatus 1000 for each application. The touch screen module 1720 may sense a touch gesture of the user on the touch screen and transmit information regarding the touch gesture to the controller 1300. According to some embodiments, the touch screen module 1720 may recognize and analyze a touch code. The touch screen module 1720 may be configured by separate hardware including a controller.

Various sensors for sensing a touch or a proximity touch on the touch screen may be provided inside or nearby the touch screen. An example of a sensor for sensing a touch on the touch screen is a tactile sensor. The tactile sensor is a sensor for sensing a contact of a specific object at a degree of human feeling or more. The tactile sensor may sense various pieces of information such as roughness of a contact surface, hardness of a contact object, a temperature of a contact point, and the like.

Another example of a sensor for sensing a touch on the touch screen is the proximity sensor 1480.

The proximity sensor 1480 may refer to a sensor for detecting whether an object approaching a predetermined detection surface or a nearby object exists by using an electromagnetic force or an IR ray without a mechanical contact. Examples of the proximity sensor 1480 are a transmissive optoelectric sensor, a direct reflective optoelectric sensor, a mirror reflective optoelectric sensor, a high-frequency oscillation proximity sensor, a capacitive proximity sensor, a magnetic proximity sensor, and an IR proximity sensor. Examples of a touch gesture of the user are a tap, a touch & hold, a double tap, a drag, a panning, a flick, and a drag & drop, a swipe.

The alarm module 1730 may generate a signal for notifying of the occurrence of an event of the display apparatus 1000. Examples of an event generated by the display apparatus 1000 are call signal reception, message reception, a key signal input, and a schedule notification. The alarm module 1730 may output an alarm signal in a video content form through the display 1210, an alarm signal in an audio signal form through the acoustic output interface 1220, or an alarm signal in a vibration signal form through the vibration motor 1230.

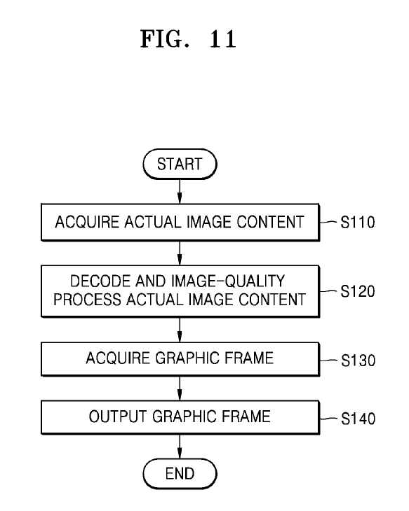

FIG. 11 is a flowchart illustrating an example method of operating a display apparatus, according to various example embodiments.

Referring to FIG. 11, in operation S110, the display apparatus may acquire actual image content from among one or more pieces of content comprising a graphic frame. In operation S120, the display apparatus may decode and image-quality process the acquired actual image content. In operation S130, the display apparatus may acquire the graphic frame by merging the image-quality processed actual image content with other content which is used in generating the graphic frame. In operation S140, the display apparatus may output the acquired graphic frame.

The actual image content may include still image content or representative image content for indicating video content. The actual image content may include a JPEG or JPG file.

The display apparatus may perform the image quality processing using a predefined conversion table in color space conversion for converting the acquired actual image content from YCbCr into RGB.

The image quality processing may include at least one of color enhancement, brightness enhancement, contrast treatment, and RGB correction.

The display apparatus may acquire a mixed frame by mixing a video frame for the video content and the graphic frame and output the mixed frame.

The method of operating the display apparatus in FIG. 11 may be performed by the display apparatus 100 or 1000 in the previous drawings. Therefore, although not described again, the operations performed by the display apparatus, which have been described with reference to FIGS. 1 to 10, may be further performed.

Various example embodiments described above can be written as computer-executable programs and can be implemented in general-use digital computers that execute the programs using a non-transitory computer-readable recording medium. Examples of the non-transitory computer-readable recording medium include storage media such as magnetic storage media (e.g., ROM, floppy disks, or hard disks) and optical recording media (e.g., CD-ROMs or DVDs).

It should be understood that the various example embodiments described herein should be considered in a descriptive sense only and not for purposes of limitation. Descriptions of features or aspects within each embodiment should typically be considered as available for other similar features or aspects in other embodiments.

While one or more example embodiments have been described with reference to the figures, it will be understood by those of ordinary skill in the art that various changes in form and details may be made therein without departing from the spirit and scope as defined by the following claims.

What is claimed is:

1. A display apparatus comprising:
a display;
a memory configured to store instructions; and
a processor configured to execute the instructions to:
acquire actual image content from among one or more pieces of content which is used in generating a graphic frame;
decode and image-quality process the acquired actual image content;
acquire the graphic frame by merging the image-quality processed actual image content with other content which is used in generating the graphic frame; and
output the acquired graphic frame to the display.

2. The display apparatus of claim 1, wherein the actual image content comprises still image content and/or representative image content indicating video content.

3. The display apparatus of claim 1, wherein the actual image content comprises one of a joint photographic experts group (JPEG) file or a JPG file.

4. The display apparatus of claim 1, wherein the processor is configured to execute the instructions to: perform the image-quality processing using a predefined conversion table in color space conversion in which the acquired actual image content is converted from YCbCr into RGB.

5. The display apparatus of claim 1, wherein the image-quality processing comprises one or more of: color enhancement, brightness enhancement, contrast treatment, and RGB correction.

6. The display apparatus of claim 1, wherein the processor is configured to execute the instructions to:
acquire a mixed frame by mixing a video frame of video content and the graphic frame; and
output the mixed frame to the display.

7. A method of operating a display apparatus, the method comprising:
acquiring actual image content from among one or more pieces of content which is used in generating a graphic frame;
decoding and image-quality processing the acquired actual image content;
acquiring the graphic frame by merging the image-quality processed actual image content with other content which is used in generating the graphic frame; and
outputting the acquired graphic frame.

8. The method of claim 7, wherein the actual image content comprises still image content and/or representative image content indicating video content.

9. The method of claim 7, wherein the actual image content comprises one of a joint photographic experts group (JPEG) file or a JPG file.

10. The method of claim 7, wherein the decoding and image-quality processing of the acquired actual image content comprises performing the image-quality processing using a predefined conversion table in color space conversion in which the acquired actual image content is converted from YCbCr into RGB.

11. The method of claim 7, wherein the image-quality processing comprises one or more of: color enhancement, brightness enhancement, contrast treatment, and RGB correction.

12. The method of claim 7, further comprising:
acquiring a mixed frame by mixing a video frame of video content and the graphic frame; and
outputting the mixed frame.

13. A non-transitory computer-readable recording medium having recorded thereon a computer-readable program for implementing the method of claim 7.
